(19) United States
(12) Patent Application Publication
(10) Pub. No.: US 2021/0095708 A1
(43) Pub. Date: Apr. 1, 2021

(54) DEVICE AND METHOD FOR AUTOMATIC APPLICATION OF A VISCOUS PRODUCT TO A RIVET HEAD

(71) Applicant: DAHER AEROSPACE, SAINT JULIEN DE CHEDON (FR)

(72) Inventors: CLAIRE DUMAS, SAINT SEBASTIEN SUR LOIRE (FR); DAVID CAZABAN-LOUSTAUNAU, NAY (FR); ALAIN TANA, TREBONS (FR); DENIS LEBEL, SEMEAC (FR)

(21) Appl. No.: 17/060,038

(22) Filed: Sep. 30, 2020

(30) Foreign Application Priority Data
Sep. 30, 2019 (FR) 19 10843

(51) Int. Cl. F16B 19/00

(52) U.S. Cl. CPC F16B 19/008; B64C 7/00

(57) ABSTRACT

A method for applying a polymerizable sealant using a device. The device includes a substantially cylindrical cartridge containing an activated polymerizable sealant. The cartridge has a distribution end and a piston. A receptacle of the cartridge having a connection interface with the distribution end thereof. The pressure acting on the piston of the cartridge ejects the activated sealant through the distribution end. An assembly of the device has a nozzle including an application orifice and a pipe to bring the sealant into the nozzle. A closure needle of the device moves in translation between a closed position where the end of the needle obstructs the application orifice of the nozzle and an open position where the end of the needle is distant from the application orifice.

### RELATED APPLICATION

This application claims priority from French Patent Application No. 19 10843 filed Sep. 30, 2019, which is incorporated herein by reference in its entirety.

### TECHNICAL FIELD

The invention relates to a device and a method for applying a viscous product, such as a sealing sealant, to a precise zone.

The invention is more particularly, but not exclusively, adapted to the aeronautical field and to the application of a polymerizable sealant, more specifically to the production of the coverage of a rivet head emerging from a sheet, by a manual or automatic operation.

Applying a sealant aims to waterproof assemblies, in particular in the field of aircraft structures.

Thus, according to an exemplary operation, the sealant is applied in the form of a bead along the edges of assemblies, with or without overflow onto the surfaces of the assembled parts.

According to another exemplary operation, the sealant is deposited on rivet heads set along an assembly line or “seam”, this operation of waterproofing of the assembly by rivets normally being referred to as “buttoning”.

### BACKGROUND OF THE INVENTION

The deposition of the sealant must meet various constraints, in particular the quantity deposited must be just sufficient both to ensure watertightness and not to unnecessarily making the assembly heavier.

The bead or the coating of the rivet head must meet geometric constraints, in particular in terms of cross-section. Said cross-section must be uniform over the entire length of the bead, without any folding, and the coating must cover the entirety of the rivet head with a substantially constant thickness of sealant greater than a minimum at every point on said rivet head.

For this purpose, a bead is deposited manually or by means of a caulk gun, with manual smoothing with a spatula to obtain the required cross-section.

The coating of the rivet heads is performed with a special nozzle and requires dexterity of a skilled operator to be even and without any drips or sag.

These operations are thus lengthy and expensive and made even more complex when they must be carried out in the pre-hardening time of the polymerization of the sealant.

When being deposited with a caulk gun, the sealant is ejected through a nozzle that gives substantially the cross-section of the sealant deposited, which corresponds to the cross-section of the bead according to an exemplary implementation.

The dexterity of the operator enables him to adapt the speed of movement of this nozzle along the contour of the part, so as to obtain a constant bead cross-section. Since the caulk gun is equipped with a trigger, the operator adapts the rate to ensure uniformity of the bead.

The most critical areas, when using a caulk gun, are the starts and ends of the bead, that is to say areas where the speed of deposition accelerates and decelerates, and also the connection regions, when the sealant cartridge must be changed during the deposition of a bead.

It is normal for the operator to smooth these regions where the bead starts and ends by means of a spatula.

In the case of the coating of a rivet head, the operator proceeds in a similar manner, moving the nozzle around and over the rivet head so as to carry out the coating with, where necessary, finishing with a spatula.

Since these operations are not very reproducible, it is difficult to automate the deposition of a bead of sealant or the coating of a rivet head. The document U.S. Pat. No. 5,312,016 describes a device for applying a sealant through a nozzle.

This device comprises a pump and complex control means making it possible to adjust the pressure and the flow rate of sealant according to the application conditions.

This device of the prior art is not adapted to the context where various types of sealant are applied and in the case where the sealant is applied under temperature and relative-humidity conditions that may vary.

Apart from the lack of flexibility in the change of the type of sealant, the polymerization of the sealant in such a system of the prior art makes the latter unusable at least during the time of the cleaning thereof, which is itself complex.

In the aeronautical field, the sealants are generally dual-component sealant delivered in a cartridge.

Said cartridge comprises either the two components already mixed. The cartridge is then frozen and heated before application, which has the effect of triggering polymerization.

Or, the two components are already pre-dosed in the cartridge and put in contact with each other at the time of use of the cartridge.

Thus, at the time of its application, the sealant is said to be “activated”.

The document DE8336955 describes a gun for depositing a sealant contained in a cartridge. Said gun comprises a nozzle and a device for opening and closing the supply of sealant from said nozzle by a device using a needle valve.

The document CN208116082 describes a device for dispensing a glue adapted to be used by a robot, in particular for the movement thereof and the delivery of the glue by action on a piston.

The document US20110300295 describes a device for applying a hot-melt adhesive on a surface in the form of droplets, said droplets being calibrated at the time of the application thereof by means of a nozzle distant from the application surface the nozzle being closed by a needle.

The devices described in these 3 documents of the prior art all include a needle for enabling or interrupting the flow of material delivered.

However, they present the drawback that all or part of the needle is located in the flow of material delivered, even when said needle is retracted in the opening position.

Although this situation is not a big deal when the product distributed is fluid, it is more problematic when the product is viscous, such as a waterproofing sealant, since, the needle interferes with the flow of sealant, causing shearing in the flow, which may lead to deficiencies in the deposited sealant bead or coating, and in all cases hinders the reproducibility of the results, and furthermore, the needle shall be dimensioned no to bend under the forces it undergoes through this flow, to avoid damaging the opening and closing mechanism or to make it unreliable, which leads to use thicker needles which, consequently, further interfere with the flow of the sealant.

### SUMMARY OF THE INVENTION

The invention aims at solving the deficiencies of the prior art and to this end relates to a method for applying a polymerizable sealant and carrying out a coating of a rivet head emerging from a sheet using a device comprising:

a substantially cylindrical cartridge containing an activated polymerizable sealant, said cartridge having a distribution end and a pressure end;

a receptacle of said cartridge comprising a connection interface with the distribution end thereof;

pressure means acting on the pressure end of the cartridge to cause the ejection of the activated sealant through the distribution end;

an application assembly comprising a sealant-feed pipe in a buttoning nozzle that comprises a pre-filling chamber, a bell-shaped cavity adapted to fit on top of a rivet head, an application orifice between the pre-filling chamber and the bell-shaped cavity;

a closure needle, able to move in translation between a closing position where the end of the needle obstructs the application orifice of the nozzle and an opening position where the end of the needle is distant from the application orifice;

means for moving the needle in translation between the opening and the closing positions;

automation means for sequencing the action of the pressure means and the movement of the needle between the opening and the closing positions;

the method comprising the steps of:

a) in a positioning step, placing the nozzle so as to fit on top of the rivet head, the application assembly being filled with sealant, the needle being in the close position, moving the pressure means so as to achieve a predetermined pressure in the feed pipe and the pre-filling chamber of the application assembly;

b) in a begin of coating step, moving the needle into the opening position so as to open the application orifice and to allow flow of the sealant in the cavity and onto the rivet head;

c) in an end of coating step, moving the needle into the closing position and stopping the flow of the sealant;

d) in a displacement step, the needle remaining in the closing position, releasing the nozzle from the rivet head and moving the device to the following rivet head, and then resuming the cycle at step a) on said following rivet head;

wherein, in the positioning step a), the nozzle is positioned above the rivet head, the end of the nozzle being located at a distance from the sheet to enable air to escape during step b).

Thus, the use of this method-associated device makes it possible to deliver a precise reproducible quantity of sealant for coating a rivet head. In particular, the opening and closing of the orifice connecting the feed channel by the needle make it possible to avoid the creation of sealant threads between the sealant deposited and the nozzle and thus avoids soiling the part outside the planned depositions areas.

The invention is advantageously implemented according to the embodiments and variants described below, which are to be considered individually and in accordance with any technically effective combination.

According to an embodiment, the end-of-coating step c) comprises a time delay between the closure of the application orifice by the needle and the movement step d). This time delay, dependent on the size of the rivet head and the viscosity of the sealant, ensures uniform coverage of the rivet head.

Advantageously, the application assembly further comprises a zone for guiding the needle in translation, the application assembly being removable from the device independently of the needle, the nozzle also being removable form the device, and wherein, if the end of the cartridge is detected between steps d) and a), the method comprises an initialization step comprising the steps of replacing the empty cartridge with a new activated-sealant cartridge, changing the removable application assembly and filling the feed pipe and the pre-filling chamber while the needle is in the opening position, and then moving the needle in the closing position before moving to the positioning step a). Thus it is possible to change the cartridge during a buttoning operation while keeping reproducible results.

Advantageously, the guiding zone opens into the feed pipe and the end of the needle is comprised in the guiding zone when the needle is retracted in the opening position during step b). Thus, no obstacle opposes the flow of the sealant in the feed pipe.

Advantageously, the nozzle of the device comprises crenellations at the end thereof, said crenellations forming openings over a height adapted to allow the air to escape during the coating, when the end of the nozzle is in contact with the sheet during step b). Thus the positioning of the nozzle with respect to the metal is simplified during coating steps.

Advantageously, the device comprises automation means for sequencing the action of the pressure means and the movement of the needle between the opening and closing positions, the device being attached to a robot or a manipulator comprising programmable control means, whereby steps a) to d) are performed automatically according to a program. Thus the method of the invention is implemented automatically.

### BRIEF DESCRIPTION OF THE DRAWINGS

The invention is described below according to the preferred embodiments thereof, in no way limiting, and with reference to FIGS. 1 to 6, wherein:

FIG. 1 depicts in a perspective view an exemplary embodiment of the device that is the object of the invention;

FIG. 2 is a view in cross-section of an exemplary embodiment of a sealant cartridge;

FIG. 3 shows, in a partial view in cross-section AA defined in FIG. 1, an exemplary embodiment of an application assembly of the device that is the object of the invention;

FIG. 4 depicts, in a partial view in cross-section like FIG. 3, an exemplary embodiment of the application assembly comprising a buttoning nozzle;

FIG. 5 depicts, in a front view, a variant embodiment of the buttoning nozzle of FIG. 4;

FIG. 6 is a block diagram of the method that is the object of the invention, applied to the performance of a buttoning operation.

### DETAILED DESCRIPTION OF THE EMBODIMENTS

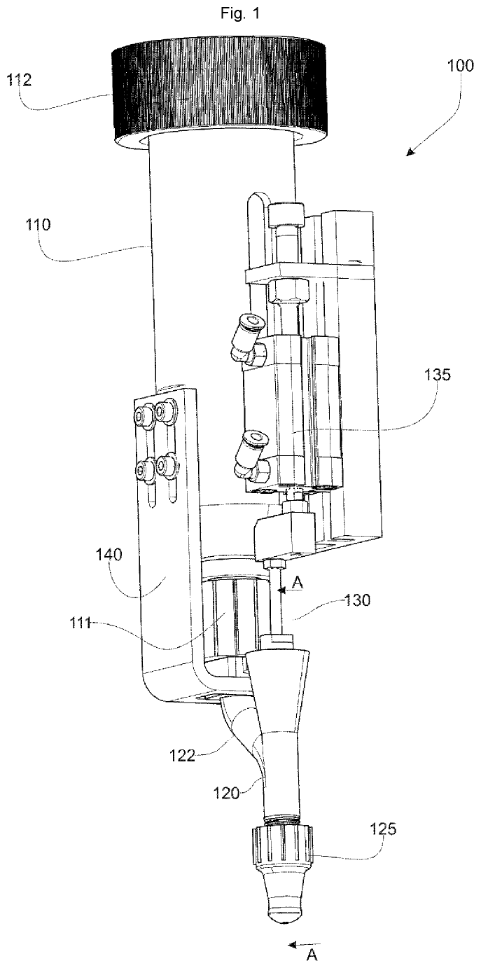

FIG. 1, according to an exemplary embodiment, the device of the invention comprises an assembly (100) for applying a sealant.

Said assembly comprises a receptacle (110) adapted to accommodate a cartridge (not shown) comprising an activated polymerizable sealant, that is to say the sealant being a dual-component sealant the polymerization of which is activated by the mixing of said components, the cartridge comprising the two mixed components is frozen, and thawed before being installed in the receptacle.

According to another embodiment, the cartridge comprises the two non-mixed components and these are mixed, causing activation, by injection or by rupture of a barrier internal to the cartridge before application.

The activated sealant has a viscosity generally comprised between 500 and 1500 Pa·s, however the device of the invention is suitable, after tests, for the application of products that are more viscous or less viscous than this range.

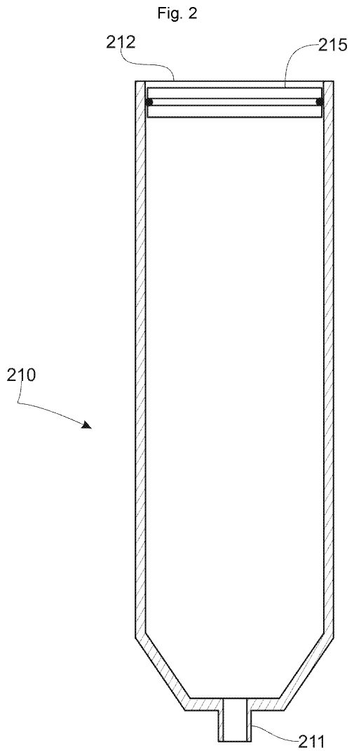

FIG. 2, according to a schematic exemplary embodiment, the cartridge (210) comprises two ends, a distribution end (211) through which the sealant flows, and the opposite so-called pressure end (212), comprising a piston (215) able to slide inside the cartridge and the movement of which pushes the content towards the distribution end.

Returning to FIG. 1, the cartridge being placed in the receptacle (110), the latter comprises an interface (111) able to receive the distribution end of said cartridge.

At the other end of the receptacle, coupling means (112) make it possible to connect it to a cylinder device (not shown) able to apply a pressure to the piston of the cartridge and to move it in the body of the cartridge so as to cause the flow of the sealant through the distribution end.

The device comprises an application assembly (120), preferentially removable in a single.

This application assembly (120) comprises a removable nozzle (125).

For this purpose the application assembly comprises arrangements at the end thereof, for example a thread, for installing the removable nozzle (125) thereon.

Thus, the application assembly is able to receive various types of nozzle according to the type of operation to be performed and the nature of the product being deposited.

The removability of the nozzle also makes it possible to dismantle it for the purpose of replacement or cleaning thereof if it comes to be clogged.

The sealant is brought into the nozzle (125) through a feed pipe (122) in hydraulic connection with the distribution end of the cartridge.

A needle (130), controlled by a pneumatic, or alternatively an electric, cylinder (135), makes it possible, through the axial movement thereof, to obstruct or to open the distribution of sealant depending on the position of the needle end (131).

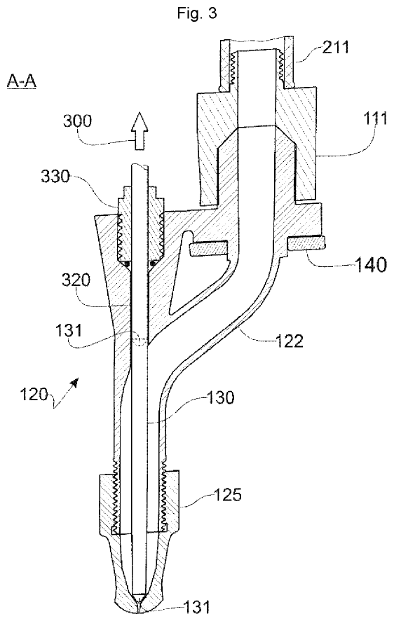

FIG. 3, the application assembly (120) is a single-piece assembly, advantageously made of a polymer having a low coefficient of adhesion with the sealant.

According to this exemplary embodiment, this assembly is kept secured to the receptacle by a bracket (140).

The application assembly comprises a zone (320) for guiding the needle (130) in translation. The needle is shown in this figure in the closure position. By moving the needle (130) in the direction of the arrow (300), the flow of the sealant is released.

The guiding zone (320) opens into the feed pipe (122). In the retracted position, shown in dotted lines in FIG. 3, the end (131) of the needle (130) is translated so that it is comprised in the guiding zone (320). Therefore, in such a position, the needle does not interfere with the flow of sealant in the feed pipe (122).

Thus, in order to fill the application assembly, the needle being in the retracted position, a movement of the piston (215, FIG. 2) of the cartridge ejects the sealant through the distribution end (211) of said cartridge and fills the pipe (122) down to the end of the nozzle (125).

The pipe (122) being completely filled, the needle is moved to the closing position. Since the needle is thin, it easily penetrates through the sealant contained in the feed pipe (122) until it meets the orifice of the nozzle, which it obstructs by its end (131), stopping the flow of the sealant through this orifice.

Continuing the pressure on the piston of the cartridge makes the pressure rise therein and in the feed pipe (122) to a pressure referred to as the initial pressure.

This initial pressure, which is dependent on the movement of the piston of the cartridge and the compressibility of the sealant applied, is easily translated into a given motion of the cylinder acting on said piston.

If the needle (130) is then moved in the direction of the arrow (300), to its retracted position where its end is comprised in the guiding zone (320), the flow of the sealant is released and the latter immediately flows through the nozzle (125).

The instantaneous flow rate at the opening is dependent in particular on the viscosity of the sealant and the initial pressure.

This initial pressure is determined according to the deposition conditions by trials, and results in a length of travel of the cylinder acting on the piston, a value that is then recorded on an abacus or in a database for each application case.

At the end of the application, the distribution of sealant is instantly stopped, without making a drop, by returning the needle (130) to the position of obstruction of the flow.

The relatively sharp shape of the end of the needle also has the effect of cutting any connection between the sealant deposited and the nozzle, preventing the formation of threads.

Following the deposition, the application assembly (120) is easily removed just after use, by loosening the bracket (140), disconnecting it from the needle (130) and loosening the fitting (330).

Once removed, it is easily cleaned, as is the needle (130) if necessary.

Cleaning is carried out by means of solvents, it is all the easier since this cleaning is carried out before complete polymerization of the sealant.

After polymerization, a mechanical action associated with commercial stripping products is necessary.

Advantageously, a new application assembly is installed as soon as the first is removed, and the cleaning of this first assembly is thus carried out in deferred time and does not reduce productivity.

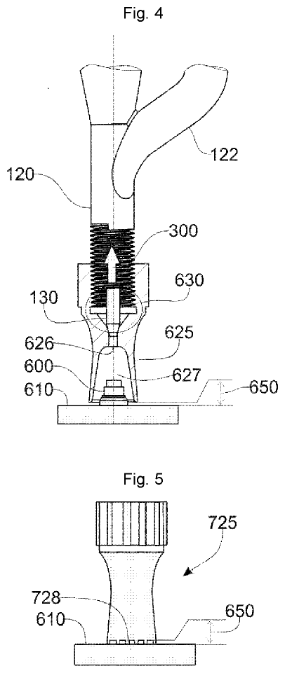

FIG. 4, for carrying out the coating of a rivet head (600) emerging from a sheet (610), the device of the invention uses a nozzle (625) adapted for this purpose, referred to as a buttoning nozzle.

The term sheet must be interpreted in a general way and encompasses any metal or composite surface of a part being the subject of assembly by riveting, particularly in the aircraft structure field. Thus, according to the application cases, the term sheet designates for example an aircraft fuselage panel or the flange of a profiled member such as the plate of a stringer, of a frame or of a fitting, assembled on such a fuselage panel, or any other structural element, without these examples being limitative.

In the same way, the terms rivet and rivet head must be interpreted in the context of aircraft structures such as any assembly or fixing element comprising a part protruding with respect to the sheet, and, apart from conventional rivets, comprises blind rivets, fastenings of the LGP®, HILITE® or HI-LOCK® type or any other fastening that might require such coating.

Said buttoning nozzle is installed on the threaded end of the application assembly (120).

Installed on the end of the application assembly, the nozzle comprises a pre-filling chamber (630) in communication with a cavity (627) substantially in a bell shape, by means of an orifice (625) referred to as the application orifice.

Said application orifice can be closed off by the needle (130). FIG. 4 shows the device in the configuration where said orifice (626) is closed off by the needle. During an operation, in this configuration, the pre-filling chamber (630) is filled with sealant, as is the feed pipe (122).

The sealant is brought into the pre-filling chamber (630) from the cartridge through the feed pipe (122) under the effect of the pressure means (not shown).

When the needle (130) is moved from this configuration in the direction of the arrow (300), the application orifice (626) is opened, putting the prefilling chamber (630) in communication with the bell-shaped cavity (627) towards which the sealant flows.

The shape and the dimension of the cavity (627) are adapted to the rivet head (600) that is to be coated, the same nozzle being adapted to a plurality of rivet heads.

In order to perform the coating of the rivet head, the end of the nozzle is positioned at a distance (650) from the sheet (610) from which the rivet head (600) emerges, to enable the air to escape when the sealant is transferred from the pre-filling chamber (630) into the cavity (627). This distance is dependent on the size of the rivet head, it is necessarily very much less than the height of the head protruding with respect to the sheet, generally this distance (650) is around in the millimeter range, commonly 2 mm, and is, according to exemplary embodiments, imposed by the operator using the device, or by the programming of the robot during an automated buttoning operation.

This embodiment makes it possible to use the same nozzle shape for a variety of rivet heads.

FIG. 5, according to another alternative embodiment, the nozzle (725) includes crenellations (728) at the end thereof. The height (650) of the crenellations makes it possible to provide openings at the periphery of the end of the nozzle when the latter is in contact with the sheet (610) from which the rivet head emerges, to enable air to escape during the coating of said rivet head.

This embodiment is simpler to implement since there is systematically contact of the end of the nozzle with the sheet and the height and number of crenellations is optimized, for example by tests, for a rivet type or a given rivet range.

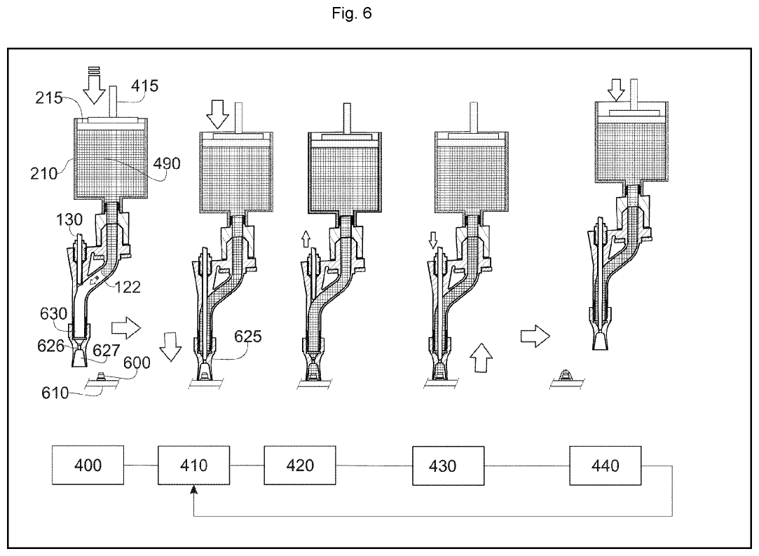

FIG. 6, according to an exemplary embodiment, the device is used for performing a buttoning operation.

According to variants, the steps for implementing this operation are performed manually or automatically.

According to the latter variant, the device is attached to a robot or a manipulator (not shown) using coupling means (112, 140, FIG. 1).

The pressure means acting on the piston (215) of the cartridge (210) are for example carried by said robot in the form of a cylinder (415) acting on said piston.

The movement of this cylinder is controlled for position and speed by the control panel of the robot, in accordance with techniques known from the prior art, a control panel that also controls the cylinder controlling the movement of the needle (130).

Thus, coupled to a robot, the device makes it possible to deposit sealant at defined locations along a path, for example for a buttoning operation, or also to produce continuous beads on a programmed path, the movement of the device along these paths being performed by the robot.

According to the type of operation sought, a different nozzle is used. Thus, for producing a continuous bead of sealant, a nozzle (125) as shown in FIGS. 1 and 3 is preferentially used whereas, for a buttoning operation, a nozzle (625, 725) as shown in FIGS. 4 and 5 and comprising a pre-filling chamber and a bell-shaped cavity, in which the needle is able to close off communication between the two, is preferred.

The device thus described is used according to the invention for producing the successive covering of rivet heads emerging from a sheet, by moving the device from one rivet head to another, either manually or in a programmed sequence and using automation means for sequencing the actions on the pressure means and on the needle.

In all cases the implementation of the method of the invention makes it possible to deliver the appropriate quantity of sealant for each rivet head, this quantity being sufficient to satisfy the coating conditions while avoiding burrs, overflows and soiling outside the rivet heads, ensuring at the same time savings in the quantity of sealant used.

According to an initialization step (400), the cartridge (210) is installed in the receptacle, and the thrust cylinder (415) comes into contact with the piston of the cartridge. The needle (130) is placed in the position of opening the orifice (626) between the pre-filling chamber and the cavity (627). Outside the part or the assembly on which the buttoning is to be performed, the piston is moved so as to fill the application assembly, that is to say the feed pipe (122) and pre-filling chamber (630), until sealant escapes through the nozzle (626).

Said sealant that escapes is lost but represents a very small quantity and this initial step is performed only at each change of cartridge.

The needle (130) being in the open position, the air can escape through the nozzle when the feed pipe (122) and the pre-filling chamber (630) are filled.

As soon as the application assembly is filled, the needle is moved into the closed position and the buttoning operation can start.

According to a positioning step (410), the device is moved above the first rivet head to be coated so that the nozzle (625) covers said rivet head (600), while leaving sufficient space between the end of the nozzle and the sheet (610) so as to enable air to escape during coating.

Simultaneously with this movement or, according to variant embodiments, prior to or following it, the thrust cylinder (415) is moved by a predetermined distance, pushing on the piston (215) of the cartridge.

Under the effect of this initial pressure, the needle still closing off the orifice (626) of the nozzle, the sealant is ejected out of the cartridge and fills the pipe (122) of the application assembly and the pre-filling chamber (630) before achieving a predetermined initial pressure.

The cross-section of the cartridge being comparatively large compared with the cross-section of the feed pipe, this initial pressure is dependent on the movement of the piston (215) and the same relative movement of the piston causes a substantially constant pressurized, almost until the cartridge is emptied and as long as the process is taking place in the opened time of the sealant in terms of polymerization.

In a start-of-coating step (420), the needle (130) is moved so as to open the orifice, which puts the bell-shaped cavity (627) of the nozzle in communication with the pre-filling chamber (630), which has the effect of filling the cavity (627) around the rivet head.

In an end-of-coating step (430), the needle (130) is moved in the opposite direction so as to close off the application orifice (626).

The time separating the two moves of the needle corresponding to the start and end of the coating and is determined according to the viscosity of the sealant, the volume of the cavity (627) and the volume of the rivet head.

These values are determined by prior tests and are set out in tables, nomograms or databases.

Closure of the application orifice (626) by the needle during the end-of-coating step (430) instantly stops the flow of the sealant in the cavity (627), and makes it possible to deliver the quantity of sealant necessary and sufficient for performing the coating.

The time separating the opening and closing of the orifice being reproducible, the pressure applied to the sealant prior to the opening also being reproducible, the quantity of sealant deposited on each rivet head of the buttoning operation is also reproducible.

In a movement step (440), a first movement makes it possible to move the nozzle away from the rivet head and then to move the device above the following rivet head to be coated.

According to a variant embodiment, a time delay is observed between the end-of-coating step (430) and the movement step (440). This time delay is dependent on the size of the rivet head to be coated and the quantity of sealant being deposited. It is generally less than 5 seconds, preferentially less than 2 seconds and preferably again less than 1 second, and is fixed so as to be just necessary for ensuring the quality of the coating while preserving the productivity of the buttoning operation.

The nozzle being positioned above the following rivet head, if the content of sealant remaining in the cartridge is sufficient, the cycle described above resumes at the initial pressurization step (410).

The end of the cartridge is easily detected by the position of the thrust cylinder.

In the event of replacement of the cartridge, the application assembly is preferentially replaced at the same time, so as avoid the mixing of sealants having different pre-hardening times.

Thus, in the event of replacement of the cartridge during a buttoning operation, resumption of the operation includes the performance of an initial step (400) aimed at achieving the initial pressure in the application assembly.

The above description and the exemplary embodiments show that the invention achieves the aim sought. The sealant-deposition device can be automated easily by virtue of the control of the needle closing/opening the nozzle, which allows the coating of the rivet heads in a reproducible way but also starts and ends of a bead without defect, according to the application sought.

Thus, the quantity of sealant deposited is controlled and reproducible, which makes it possible in particular to automate the buttoning operations.

This device uses standard sealant cartridges.

The application assembly can be exchanged quickly and is easy to clean.

Thus, the cartridge can be changed at the same time as the application assembly during a buttoning operation, without compromising the reproducibility of the results.

1. A method for applying a polymerizable sealant and coating of a rivet head emerging from a sheet using a device comprising:
a substantially cylindrical cartridge containing an activated polymerizable sealant, said cartridge comprising a distribution end and a piston to push a content towards the distribution end;
a receptacle of said cartridge comprising a connection interface with the distribution end thereof;
wherein the piston of the cartridge is configured to eject the activated polymerizable sealant through the distribution end in response to a pressure acting on the piston;
an application assembly comprising a sealant-feed pipe in a buttoning nozzle that comprises a pre-filling chamber, a bell-shaped cavity adapted to fit on top of the rivet head, an application orifice between the pre-filling chamber and the bell-shaped cavity;
a closure needle configured to move in translation between a closing position where an end of the closure needle obstructs the application orifice and an opening position where the end of the closure needle is distant from the application orifice;
a cylinder to control movement of the needle in translation between the opening position and the closing position; and
wherein actions of the piston and the cylinder are sequenced;
the method comprising:
a) at a positioning step, placing the nozzle to fit on top of the rivet head, the application assembly being filled with the activated polymerizable sealant, the closure needle being in the close position, applying pressure on the piston to achieve a predetermined pressure in the sealant-feed pipe and the pre-filling chamber of the application assembly;
b) at a start of a coating step, the cylinder moving the closure needle to the opening position to open the application orifice and to allow a flow of the activated polymerizable sealant in the bell-shape cavity and onto the rivet head;
c) at an end of the coating step, the cylinder moving the closure needle to the closing position and stopping the flow of the activated polymerizable sealant;
d) at a displacement step, the closure needle remaining in the closing position, releasing the buttoning nozzle from the rivet head and moving the device to a next rivet head, and then repeating steps a)-d) on the next rivet head;
wherein, at the positioning step, the buttoning nozzle is positioned above the rivet head, the end of the buttoning nozzle being located at a predetermined distance from the sheet to enable air to escape during step b).

2. The method of claim 1, further comprising a time delay between the closure of the application orifice by the closure needle in the end of the coating step c) and the displacement step d).

3. The method of claim 1, wherein the application assembly further comprises a guiding zone to guide the closure needle in translation, the application assembly being removable from the device independently of the closure needle, the buttoning nozzle being removable from the device; and wherein, in response to a detection of an end of said cartridge between steps d) and a), further comprising replacing said cartridge with a new activated-sealant cartridge, changing the removable application assembly and filling the sealant-feed pipe and the pre-filling chamber while the closure needle is in the opening position, and then moving the closure needle to the closing position before moving to the positioning step a).

4. The method of claim 3, wherein the guiding zone opens into the sealant-feed pipe and wherein an end of the closure needle is comprised in the guiding zone when the closure needle is retracted in the opening position during step b).

5. The method of claim 1, wherein the buttoning nozzle comprises crenellations at the end thereof, said crenellations forming openings over a height adapted to allow the air to escape during the coating, when the end of the buttoning nozzle is in contact with the sheet during step b).

6. The method of claim 1, wherein the device is attached to a robot or a manipulator comprising a programmable controller, whereby steps a) to d) are performed automatically according to a program.
